(19) United States
(12) Patent Application Publication
(10) Pub. No.: US 2011/0223392 A1
(43) Pub. Date: Sep. 15, 2011

(54) Removable Patch for Covering a Portion of a Body from View

(76) Inventor: Kimmerly Rene DICKEY, Okanagan Falls (CA)

(21) Appl. No.: 12/814,427

(22) Filed: Jun. 11, 2010

Related U.S. Application Data
(60) Provisional application No. 61/282,634, filed on Mar. 10, 2010.

(51) Int. Cl. B32B 3/10

(52) U.S. Cl. 428/195.1

(57) ABSTRACT

The present application is directed to patches for covering a portion of a user's body. The patch may comprise a support layer having first and second exterior surfaces. The first exterior surface may be applied to the skin of the user, and a decorative medium may be attached to the second exterior surface. The support layer may be constructed of a material having a bend stiffness sufficient to allow the support layer to bend in a simple curvature shape and generally provide resistance to bending in a complex curvature shape.

### CROSS-REFERENCE TO RELATED APPLICATIONS

The present application claims priority from co-pending provisional U.S. Patent Application Ser. No. 61/282,634 filed on Mar. 10, 2010 entitled, “Removable Patch for Buttocks Cleavage and Method for Using Same,” which is herein incorporated by reference in its entirety.

### BACKGROUND

The present invention is directed to functional and decorative products, and more specifically to removable patches wearable on the skin of a user for hiding from view a portion of the user's body. In one embodiment, the present invention may be removably applied on an upper buttocks region of the user to hide from view the cleavage of the upper buttocks when the user is wearing low-rise apparel around the waist and the user either sits, squats, or bends over so as to otherwise expose the upper buttocks above a waistband of the apparel.

So-called “plumber's-butt” or “plumber's crack” is a known, unsightly, and unfortunately overly common problem wherein the waistband of a pair of pants does not ride sufficiently high over the hip bones of the wearer. This may be due to the size of the wearer's protruding stomach which pushes down a front portion of the waistband of the pants, carrying with it a rear portion of the waistband. Other times, the problem may be caused by the cut of the pants, shirt, swimsuit, panties, and the like of the wearer in which the style and cut of the apparel dictate that the waistband rides quite low on the hips of the wearer. In either case, the sitting, squatting, or bending motion urges the waistband downward, exposing the upper portion of the buttock cleavage. Although male wearers may not be overly concerned with exposing the buttock cleavage, most female wearers would rather not inadvertently expose their buttocks cleavage.

### SUMMARY

The present invention is directed to patches for covering a portion of a user's body. The patch may comprise a support layer having first and second exterior surfaces. The first exterior surface may be applied to the skin of the user, and a decorative medium may be attached to the second exterior surface.

It is an object of the present invention to provide a device for preventing the inadvertent exposing of the user's buttock cleavage, and in particular to provide a removable patch wearable on the skin of the user to cover the buttock cleavage, where the patch may be adorned to suit the wearer's taste or desired artistic expression, or so as to display a message, branding, logo, or the like, where the patch is adapted for releasably adhering to the skin of the user without irritation, and where the method provides for correct placement and positioning of the patch on at least a portion of the buttock cleavage to both provide coverage and to provide a cooperative uncovering of at least a portion of a visible surface of the patch.

It is a further object of the present invention to provide a buttocks cleavage patch in which it is intended that, in one embodiment, one size of patch may be used for most sizes of users, and that the patch provides a resilient flexible substrate on which artistic or other visible works or media may be portrayed, or branding or seasonal messages may be displayed, and where a surface of the patch may be decorated by color or three-dimensional artwork including gemstones, glitter, studs, rivets, and other objects (collectively herein referred to as media). It is a further object to provide a patch which may be temporary in the sense that the user may remove it when desired, and where the patch may be viewed by others when applied to the upper buttocks, and approximately sized so as to be at least partially visible above the waistband of the pants, shorts, skirt, bathing suit, or like apparel when the apparel is in its normally worn position covering the buttock cleavage, but as the rear of the waistband of the apparel is moved downwardly upon the sitting, squatting, or bending motion of the user, the patch becomes increasingly exposed as upon a maximum sitting, squatting, or bending position being reached by the user.

Applicant conducted a survey of approximately 100 women having an average age in the approximate range of 31-45 years old and who each owned on average 8 to 12 pairs of jeans. Almost exclusively, the jeans were low-rise jeans, meaning that the waistband of the jeans when worn normally did not extend above the hip bone of the wearer. Although the survey did not poll teenage girls, applicant believes that the survey results would apply substantially to that age group as well. The results of the survey indicated that 70 percent of the women polled experienced exposed buttock cleavage when wearing their jeans, and that approximately 75 percent responded that such exposure bothered them. Approximately 95 percent of the women polled responded that they noticed exposed buttock cleavage on other women. About half of the women responded that they also experienced exposed buttock cleavage when wearing clothes other than jeans.

### BRIEF DESCRIPTION OF THE DRAWINGS

FIG. 1 is a rear perspective view of a depiction of typical exposed buttock cleavage of a person wherein when the person bends at the waist, pants or like apparel are pulled downwardly over the upper region of the person's buttocks thereby exposing at least a portion of the upper cleavage of the buttocks.

FIG. 2 is a rear elevation view of a user wearing a patch in the upper buttock region and positioned so that a portion of the patch is visible when low-rise pants or similar apparel is positioned in its normally worn position about the hips of the user according to one embodiment.

FIG. 3 is a rear perspective view of the user of FIG. 2 having bent at the waist by sitting so as to expose a perhaps greater portion of the patch covering the upper cleavage of the buttocks in one embodiment.

FIG. 4 is a side elevation view of the waist and buttocks area of the user with the apparel removed to more clearly show the placement of the patch covering the upper cleavage of the user's buttocks according to one embodiment.

FIG. 4a is an enlarged view of a portion of FIG. 4

FIG. 5a is a diagrammatic view of exposed buttock cleavage.

FIG. 5b is the diagrammatic view of FIG. 5a with a patch applied to the skin of a user to cover an upper portion of the buttock cleavage according to one embodiment.

FIG. 6 is a cross-sectional view of a patch applied to the skin of a user to cover an upper portion of the buttock cleavage according to one embodiment.

FIG. 7 is a cross-sectional view of a patch applied to the skin of a user to cover an upper portion of the buttock cleavage according to one embodiment.

FIG. 8 is an example patch wherein artwork is depicted on an outer surface of a patch according to one embodiment.

FIG. 9 is a further example of artwork depicted on an outer surface of a patch according to one embodiment.

FIGS. 10-19 are schematic views of shapes of a patch.

### DETAILED DESCRIPTION

The present application is directed to patches for covering a portion of a user's body. The patch may comprise a support layer having first and second exterior surfaces. The first exterior surface may be applied to the skin of the user, and a decorative medium may be attached to the second exterior surface. The support layer may be constructed of a material having a bend stiffness sufficient to allow the support layer to bend in a simple curvature shape and generally provide resistance to bending in a complex curvature shape.

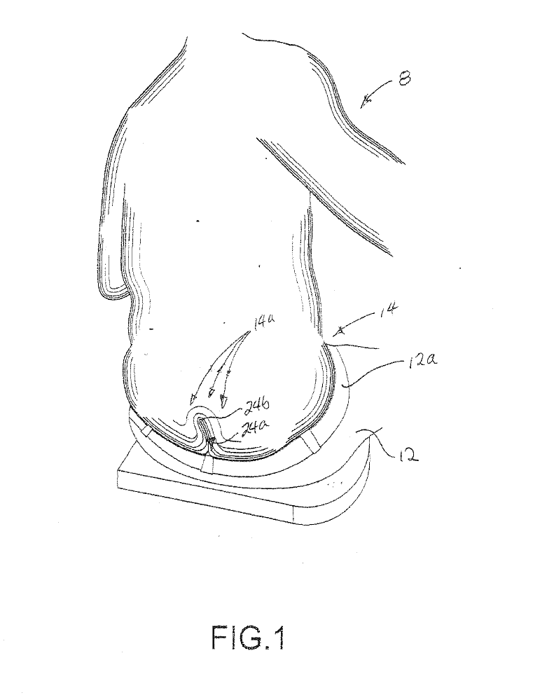

FIG. 1 illustrates how the buttock cleavage 24 may be exposed. A user 8 may wear apparel 12 such as pants, shorts, skirt, bathing suit, or like apparel having a low waistband 12a. Depending on the cut of apparel 12, the waistband 12a may be positioned about the hips of the user 8 such that the waistband 12a covers the uppermost extremity or vertex 24b of the cleavage 24. As user 8 moves into a sitting position as in FIG. 1, the waistband 12a of apparel 12 is pulled downward to a position exposing the uppermost extremity 24b of the cleavage 24, and in more extreme cases expose the cleavage crevice 24a.

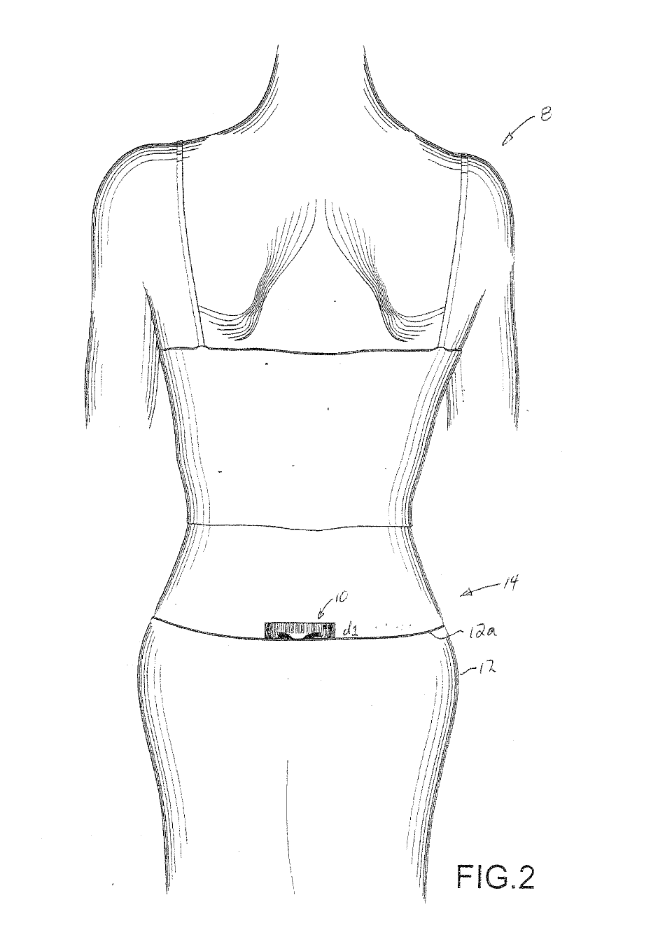

The patch 10 may be releasably attached to the skin of a user for hiding from view a portion of the user's body. In one embodiment, the patch 10 may be used to cover at least a portion of the buttocks cleavage 24 illustrated in FIG. 1. In FIG. 2, the user 8 is shown wearing low-waist apparel 12 (e.g., low-rise jeans) wherein the waistband 12a is positioned approximately on the hips of the user 8. The patch 10 may be positioned on the user 8 such that a first portion dl of the patch 10 may be visible above the waistband 12a. In one embodiment, dl may be approximately 10-15 percent of a height h of the patch 10. However, the patch 10 may be designed, or the user 8 may select to position the patch 10, such that dl is a lesser or greater amount of the height h.

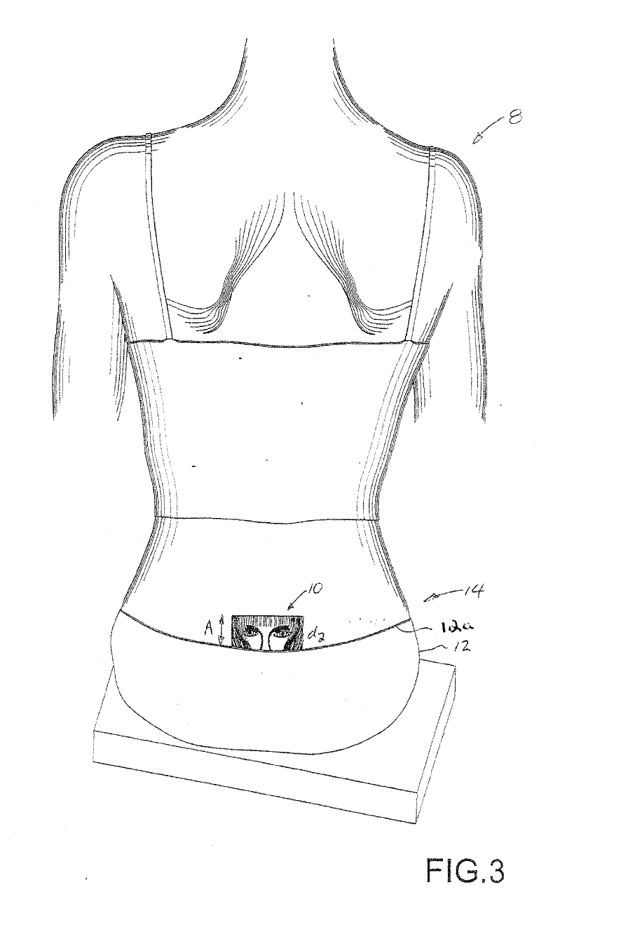

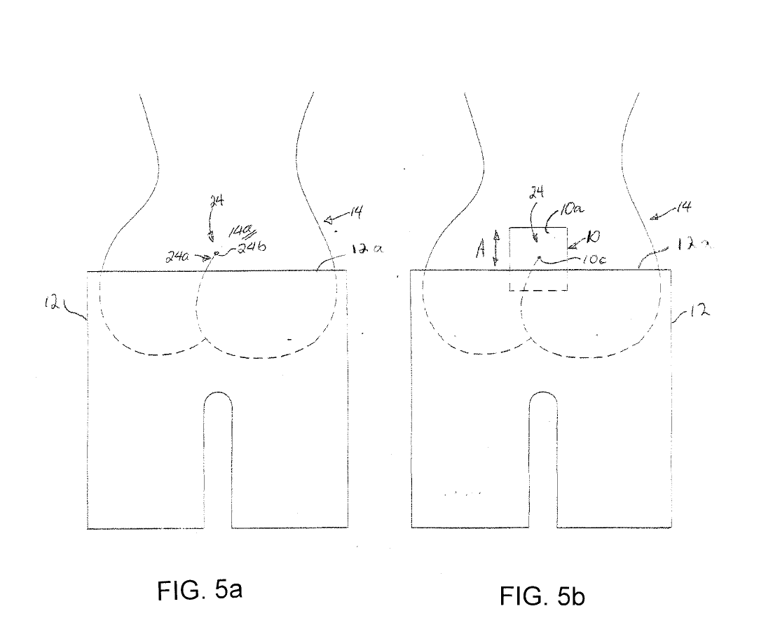

Similar to FIG. 1, FIG. 3 illustrates user 8 in a sitting position wearing low-waist apparel 12. The waistband 12a again is pulled in a downward direction such that the waistband 12a is below the uppermost extremity 24b of the cleavage 24. However, the patch 10 now covers the cleavage 24 and prevents the cleavage 24 from being visible. As the waistband 12a is pulled downward in response to sitting, squatting, or bending movement of the user 8, a portion d2 of the patch 10 may now be exposed. In one embodiment, the portion d2 is greater than the portion d1, and d2 may be as great as the height h of the patch 10. FIGS. 5a and 5b schematically illustrate the positioning of the patch 10 in relation to the cleavage 24 and waistband 12a.

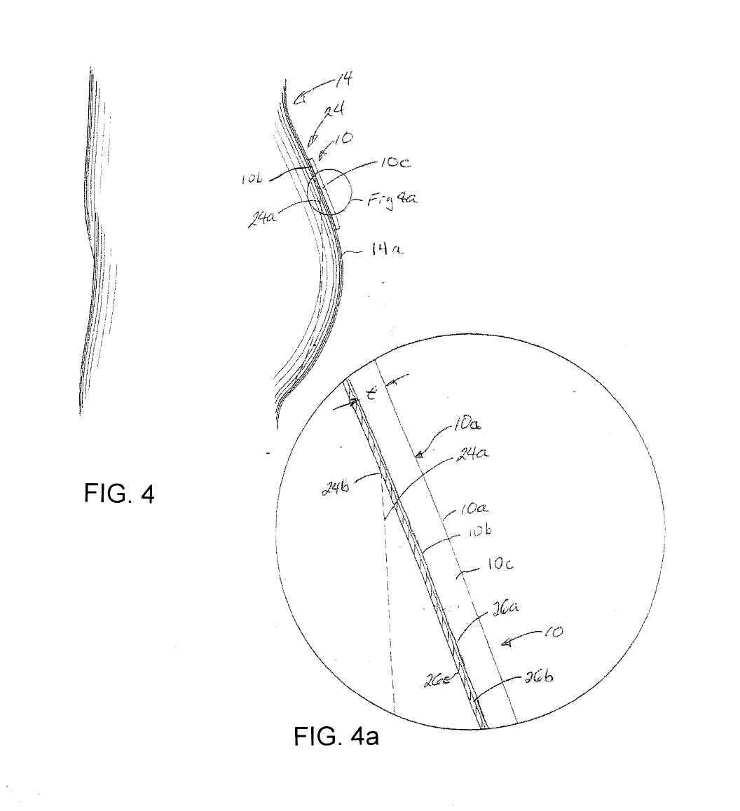

FIG. 4 illustrates the patch 10 positioned on the user 8 with a first exterior surface 10b positioned adjacent to the skin 14a a second exterior surface 10a positioned away from the user's skin 14a when the patch 10 is releasably attached to the skin 14a. The patch 10 may be positioned such that the patch 10 extends higher than the cleavage crevice 24a of cleavage 24.

As illustrated in more detail in FIG. 4a, one embodiment of the patch 10 may be comprised of a support layer 10c. In this embodiment, the support layer 10c is comprised of the first exterior surface 10b positioned adjacent to the skin 14a and the second exterior surface 10a positioned away from the user's skin 14a. The second exterior surface 10a may include a visual medium 32 imprinted or attached to the second exterior surface 10a for outward decoration. For example, the medium 32 may include coloration of any sort, works of art 16, branding or logos 18, messages 20, or three-dimensional adornments 22 such as rhinestones, glitter, studs, rivets, and the like. The visual medium 32 may be the second exterior surface 10a itself, or may be another layer or portion of a layer attached (either permanently or releasably) to the second exterior surface 10a. In those embodiments where the visual medium 32 is another layer releasably attached to the second exterior surface 10a, a number of layers of visual medium 32 may be provided such that the user 8 may interchangeably choose which layer of visual medium 32 to display. In one embodiment, the visual medium may be constructed of a material adapted to accept printing from a laser printer or ink-jet printer.

The second exterior side 10b may include an adhesive layer 26. In one embodiment, the adhesive 26 is a pressure sensitive double-coated silicone gel/acrylic adhesive supplied as Bioflex® Rx1268S by Scapa North America of Windsor, Connecticut. Bioflex® Rx1268S is a co-polyester film 26b, double-coated with a silicone gel adhesive 26c on one side and an acrylic adhesive 26a on the other side that is suitable for use of the skin. The adhesive 26 used on other embodiments may include medical tape model number MED 3044 by Avery Dennison of Pasadena, Calif. or product number 1522 by 3M Company of St. Paul, Minn. It should be readily apparent to one skilled in the art that a number of products may be used as the adhesive 26, all of which are within the scope of the present invention.

The adhesive 26 of patch 10 should sufficiently adhere to the user's skin 14a in the upper buttocks cleavage 24 area so that the patch 10 stays firmly in place until the user 8 removes the patch 10 from the skin 14a. The adhesive 26 should be sufficiently releasable from the skin 14a to prevent discomfort or skin irritation due to either the nature of the adhesive 26 or the releasing of the adhesive 26 as the patch 10 is lifted and pulled free from the skin 14a.

The entire first exterior side 10b may be coated with the adhesive layer 26, or only a portion of the first exterior side 10b may be coated. In one embodiment, the adhesive 26 is pre-applied by applying the acrylic adhesive layer 26a to the first exterior side 10b of the patch 10, with the silicone adhesive layer 26c covered by a backing sheet which the user 8 removes prior to applying the patch 10 to the skin 14a. In another embodiment, the adhesive 26 is supplied separately from the patch 10 and the user 8 applies the adhesive 26 to the first exterior surface 10b of the patch 10. For example, the user 8 may remove the adhesive 26 from the patch 10 after a number of uses and apply a new layer of adhesive 26 to the first exterior side 10b to allow continued use of the patch 10.

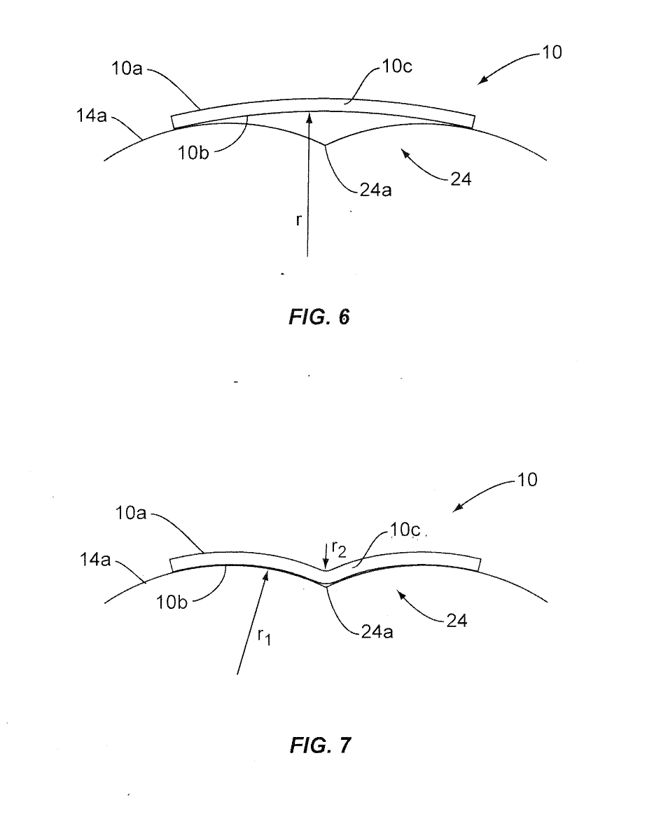

The support layer 10c of patch 10 may be constructed of a material having sufficient bending stiffness so as to allow the patch 10 to bend in a simple curvature shape (defined for the purposes herein as a curve having an essentially constant radius), and provide resistance to bending in complex curvature shapes (defined for the purposes herein as a curve having two or more radii). FIG. 6 illustrates a cross-sectional view of the patch 10 positioned over the cleavage 24. In FIG. 6, the patch 10 has acquired a simple curvature with radius r. In contrast, the patch 10 as illustrated in the cross-sectional view of FIG. 7, has acquired a complex curvature wherein a first portion of the patch 10 has a radius of r1 and a second portion of the patch 10 has a radius of r2 different than r1.

Thus, the material of the support layer 10c is selected to have sufficient bend stiffness so that the patch 10 resists conforming to the shape of the cleavage crevice 24a as illustrated in FIG. 6. That is, if the material of the support layer 10c can be easily stretched or is sufficiently thin, then the patch 10 may conform to the shape of the cleavage crevice 24a (as illustrated in FIG. 7) and would enhance the visibility of the cleavage crevice 24a rather than covering the cleavage 24 from view.

Bend stiffness as used herein refers to the resistance of a sheet material to bend out a planar shape when subjected to a force normal to a surface of the material. In other words, bend stiffness is the resistance of a body having elastic properties to deformation by an applied force. The bending stiffness (k) may be expressed as: k=P/δ, where P is a constant force applied to the body, and δ is the displacement of the body produced by the force. In one embodiment, the material of the support layer 10c has a bending stiffness in the range from about 0.01 Newtons/meter to about 10 Newtons/meter.

In one embodiment, the support layer 10c may be constructed of a woven material, such as a fabric. The fabric may be adapted to receive an image thereon such as Photweave™ material. Such material may provide a greater thickness t of the patch 10, thereby providing for a more visually appealing appearance. Other non-limiting examples of materials suitable for constructing the support layer 10c of the patch 10 may include rubber, silicone, plastic, fabric (natural and synthetic), leather, metal, and paper. One skilled in the art will recognize that other materials of construction, either alone or in combination, may be selected for the support layer 10c, all of which are within the scope of the present invention.

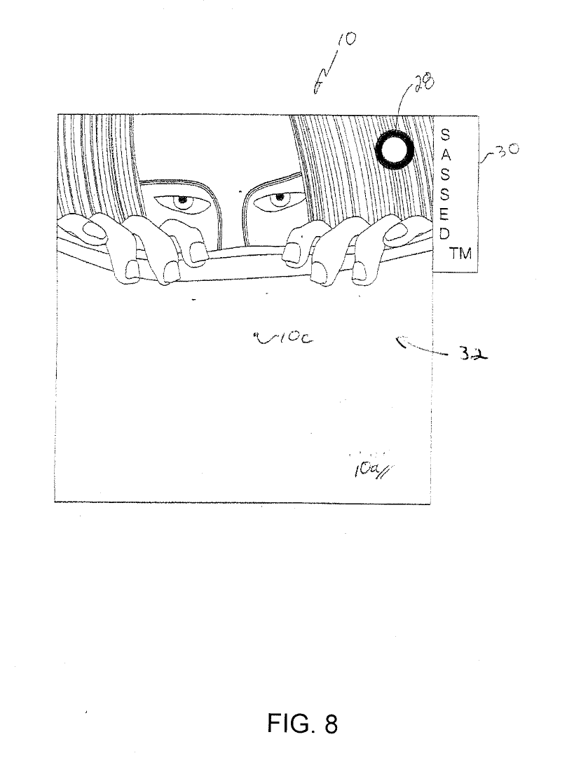

Eyelets 28 may be formed in or mounted into the patch 10, for example in one or both upper corners as illustrated in FIG. 8 Eyelets 28 may provide a mounting place for three-dimensional adornments through the use of a D-ring or carabiner (not shown). Such adornments may include jewels, gems, charms, studs, beads, and the like. A tag 30 which may be fabric or other suitable material, may be mounted to one edge the patch 10 such as a side edge as illustrated in FIG. 8. The tag 30 may act as a pull tab for the user 8 to grab onto and release the patch 10 from the skin. The tag 30 may also be used to identify the manufacturer of the patch 10.

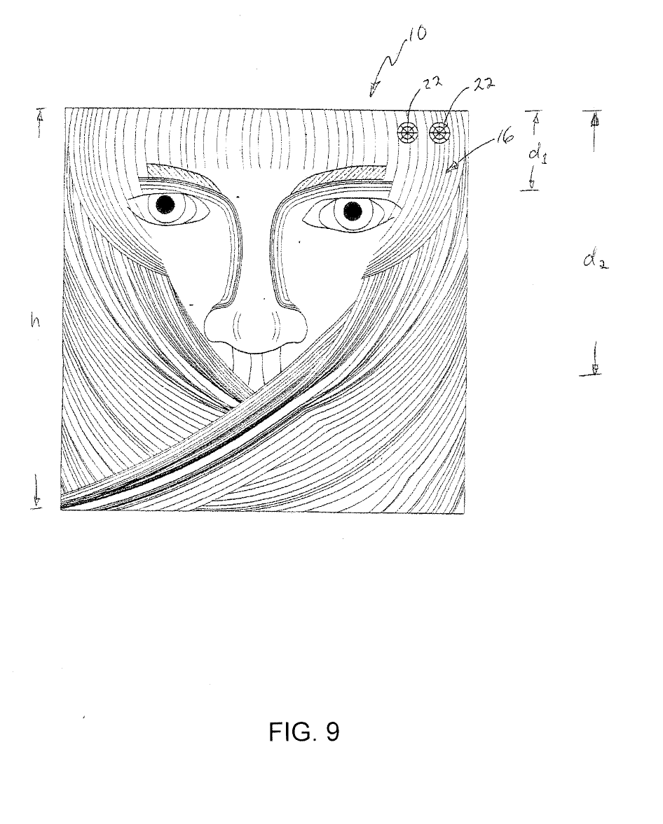

It may now be understood that the waistband 12a, by the use of the present invention, instead of exposing the user's buttock cleavage 24 when lowered, instead may function as a vertically moving shutter which as waistband 12a oscillate vertically in direction A alternately exposes and covers a portion of the visual medium 32 on the second external surface 10a of the patch 10. Thus, if the visual medium 32 or other adornment is eye-catching, the shutter effect of the vertically oscillating waistband 12a may have a provocative effect. For example, if a pair of eyes as illustrated in FIG. 8 or FIG. 9 on an upper region of the patch 10 (for example, at least the portion d1 but generally no more than d2) is visible above the waistband 12a, a casual viewer of the back of the user 8, may be taken aback as a pair of eyes comes in to view every time the user 8 bends at the waist. This effect may be varied depending on the visual medium 32 displayed on the patch 10.

The patch 10 may be useful for purposes other than hiding the buttock cleavage 24 from view. For example, the patch 10 may be used to hide breast cleavage from view, hide tattoos, hide skin blemishes, or simply add a decorative or expressive element to the user 8.

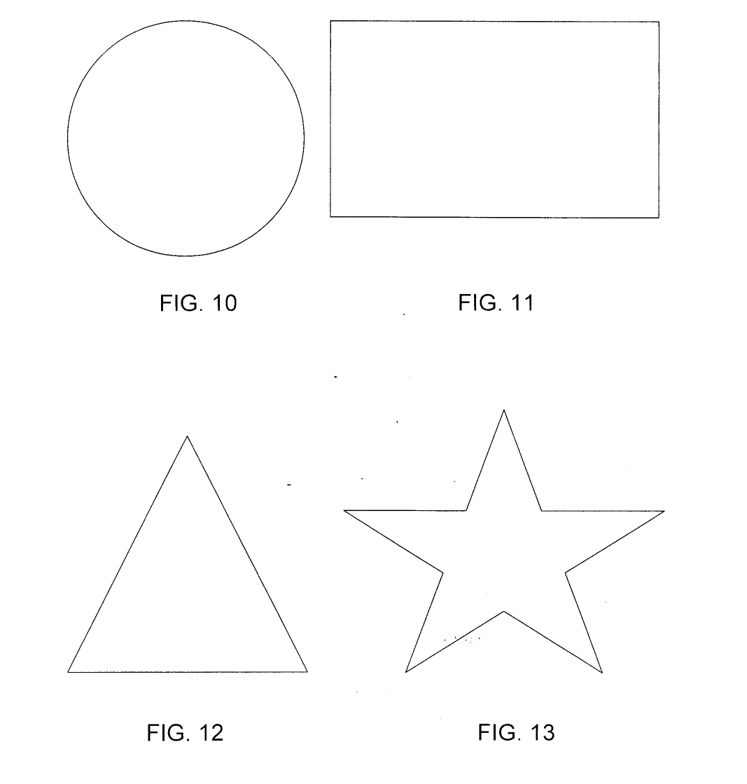

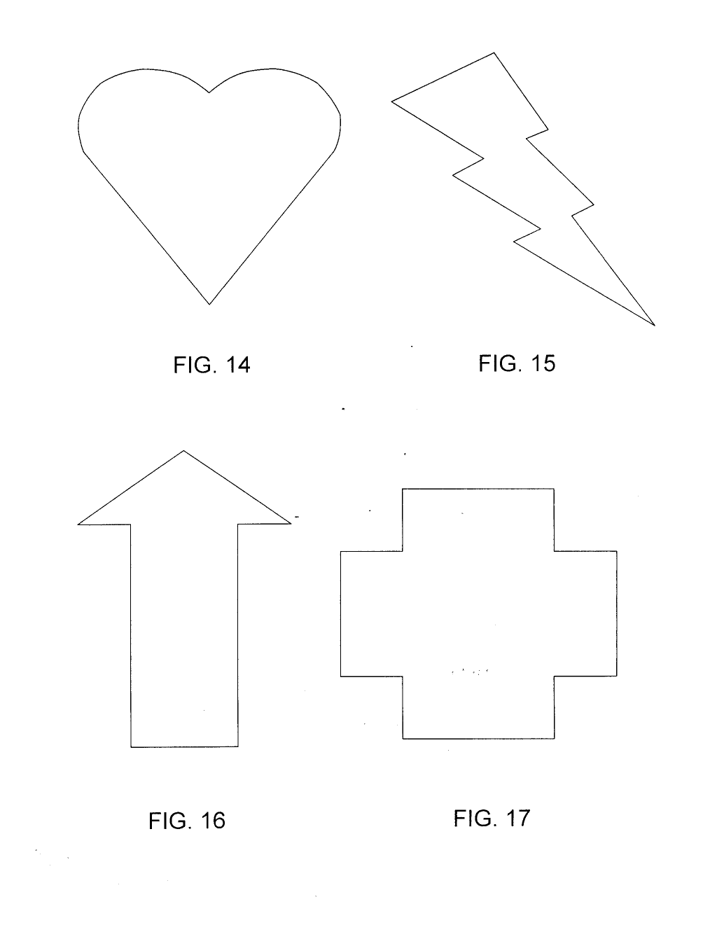

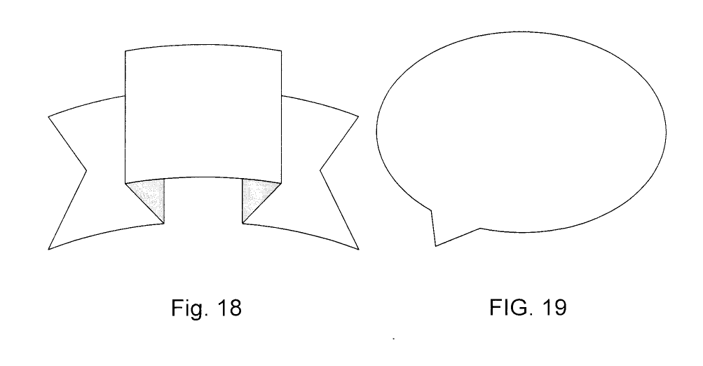

Although the foregoing figures illustrate the patch 10 in a generally rectangular shape, essentially any other shape may also be used. By way of non-limiting example, FIGS. 10-19 illustrate a number of shapes that could be used for the patch 10, including a circle, star, heart, arrow, lightning bolt, cross, banner, and the like. In one embodiment, the patch has a rectangular shape measuring about 3 inches wide and about 3 inches in length. Other embodiments may have other measurements.

In one embodiment, the patch 10 may be constructed of materials that allow the patch 10 to be reused for other purposes. For example, if the adhesive layer becomes nonfunctional after repeated uses, a fabric-based patch 10 could be used as a decorative appliqué for clothing. Other uses include scrapbooking, crafts, sewing, and the like.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A patch for covering from view a portion of a user's body, comprising:
a support layer having a first exterior surface for application to the skin of a user, and a second exterior surface opposite and essentially parallel to the first exterior surface;
a pressure sensitive adhesive layer attached to the first exterior surface; and
a visual medium attached to the second exterior surface;
wherein the support layer is constructed of a material having a bend stiffness sufficient to generally allow the support layer to bend in a simple curvature shape and generally provide resistance to bending in a complex curvature shape.

2. The patch of claim 1, wherein the visual medium further comprises a decorative layer attached to the second exterior surface.

3. The patch of claim 1, wherein the visual medium comprises a depiction of artistic expression.

4. The patch of claim 2, wherein the decorative layer is removable from the second exterior surface.

5. The patch of claim 4, further comprising a second decorative layer attached to the second exterior surface after the decorative layer is removed.

6. The patch of claim 1, wherein the pressure sensitive adhesive layer comprises a silicon gel adhesive.

7. The patch of claim 1, wherein the pressure sensitive adhesive layer is attached to a portion of the second exterior surface.

8. The patch of claim 1, wherein the pressure sensitive adhesive layer is removably attached to the second exterior surface to allow attachment of a second pressure sensitive adhesive layer after removal of the pressure sensitive adhesive layer.

9. The patch of claim 2, wherein the decorative layer further comprises a photosensitive material.

10. The patch of claim 2, wherein the decorative layer further comprises a material adapted to accept printing from a laser printer or ink-jet printer.

11. The patch of claim 1, wherein the bend stiffness of the support layer ranges from about 0.01 Newtons/meter to about 10 Newtons/meter.

12. A patch for covering from view a portion of a user's body, comprising:
a support layer having a first exterior surface for application to the skin of a user, and a second exterior surface opposite and essentially parallel to the first exterior surface;
a pressure sensitive adhesive layer attached to the first exterior surface; and
a visual medium attached to the second exterior surface;
wherein the support layer is constructed of a material having a bend stiffness sufficient to generally allow the support layer to bend in a curvature shape having an essentially constant radius and generally provide resistance to bending in a curvature shape having two or more radii.

13. The patch of claim 12, wherein the visual medium further comprises a decorative layer attached to the second exterior surface.

14. The patch of claim 12, wherein the visual medium comprises a depiction of artistic expression.

15. The patch of claim 13, wherein the decorative layer is removable from the second exterior surface.

16. The patch of claim 12, wherein the visual medium is constructed of a woven material.

17. The patch of claim 12, wherein the bend stiffness of the support layer ranges from about 0.01 Newtons/meter to about 1 Newtons/meter.

18. A patch for covering from view a portion of a user's body, comprising:
a support layer having a first exterior surface for application to the skin of a user, and a second exterior surface opposite and essentially parallel to the first exterior surface;
a pressure sensitive adhesive layer attached to the first exterior surface; and
a visual medium attached to the second exterior surface;
wherein the support layer is constructed of a material having a bend stiffness ranging from about 0.01 Newtons/meter to about 10 Newtons/meter.

19. The patch of claim 18, wherein the visual medium further comprises a decorative layer attached to the second exterior surface.

20. The patch of claim 18, wherein the visual medium comprises a depiction of artistic expression.
